(19) United States
(12) Patent Application Publication
(10) Pub. No.: US 2016/0335888 A1
(43) Pub. Date: Nov. 17, 2016

(54) MOBILE APPLICATION FOR REAL-TIME DIAGNOSIS AND OPTIMIZATION OF TRAFFIC SIGNAL SYSTEMS

(71) Applicants: Zong Tian, Reno, NV (US); Hao Xu, Reno, NV (US); Dali Wei, Woodland, CA (US); Hongchao Liu, Lubbock, TX (US)

(72) Inventors: Zong Tian, Reno, NV (US); Hao Xu, Reno, NV (US); Dali Wei, Woodland, CA (US); Hongchao Liu, Lubbock, TX (US)

(21) Appl. No.: 14/714,089

(22) Filed: May 15, 2015

(51) Int. Cl. G08G 1/07; G08G 1/01; H04M 1/725

(52) U.S. Cl. CPC G08G 1/07; H04M 1/72522; G08G 1/0125; G08G 1/0145

(57) ABSTRACT

This invention presents a mobile application for real-time diagnosis and optimization of traffic signal control systems. It utilizes innovative techniques described in this document to develop virtual signal controllers into a mobile device and takes advantage of the GPS technology equipped with the mobile device to develop vehicle trajectories. The signal timing data and the vehicle movement data are then integrated into a dynamic time-space diagram for performance analysis and signal optimization. The invention is unique in that all of the functions are developed into mobile devices and thus very user friendly and easy to carry. In addition, it provides various means and functions for traffic engineers to manage, examine and fine tune traffic signals in real-time. Compared to the traditional methods that mostly rely on the engineering judgment, the present invention facilitates traffic engineers to identify the problems and make improvements in a lot more convenient and efficient way.

### FIELD OF INVENTION

The present invention relates to the field of traffic signal system management and operations.

### BACKGROUND

Traffic signal timing is for achieving smooth movements of various transportation modes along signalized arterials and networks. In general, signal timing involves three steps: timing development, implementation, and field observations and fine-tuning. Traffic engineers first develop signal timing plans following some optimization rules and operational objectives; then the timing plans are programmed into the traffic signal controllers; finally, field observations and fine-tunes are conducted to ensure accurate and best performance of the signal timing. The primary objective of signal timing is to minimize vehicle delays and stops when traveling along an arterial. Poorly timed traffic signals result in excessive delays and stops, which translate into increased costs to the road users due to waste in time increased fuel consumption and hazardous emissions.

Traffic engineers need to check the status of traffic signals and examine the performance of the signal timing plans on a regular basis. In lack of convenient and useful tools, this routine, normally done through field observations, is tedious and time consuming because in many cases the diagnosis of signal timing problems relies primarily on the perception and judgment of the observer. In reality, traffic signals are prone to malfunctions. The causes are manifold, which include but are not limited to the following cases: signal controller clock not synchronized with other signals in the system; wrongly coded signal timing plan such as the offset and phasing sequence; signal transition after preemption by emergency vehicles; and outdated timing plans that do not keep up with the change of traffic flow patterns. Current solutions to identifying such problems require transportation engineers to drive along the signalized arterial and use tools like a stopwatch to check the controller status located in the signal cabinet. Due to its time-consuming process, it is impossible for engineers to quickly diagnose and re-time the signals onsite. Therefore, there is a strong demand for a mobile tool that is packed with modern technologies which can be used to diagnose, develop, and implement new traffic signal timing plans onsite and in real time.

### BRIEF DESCRIPTION OF THE DRAWINGS

The related drawings, which form a part of the specification, illustrate the embodiments of the invention and serve to explain the principles and functions of the invention.

FIG. 1 is an illustration of the system structure of the mobile application with an embodiment described herein.

FIG. 2 is a flow chart illustrating the operation process of the mobile application with an embodiment described herein.

FIG. 3 is the display of an interface for editing a transportation agency's information in accordance with an embodiment described herein.

FIG. 4 is the display of an interface for editing a subsystem's information in accordance with an embodiment described herein.

FIG. 5 is the display of an interface for editing signal timing patterns in accordance with an embodiment described herein.

FIG. 6 is the display of an interface for time synchronization in accordance with an embodiment described herein.

FIG. 7 is an illustration of the signal timing viewer with an embodiment described herein.

FIG. 8 is an illustration of the signal timing editor with an embodiment described herein.

FIG. 9 is the display of the map view of the signalized intersections in accordance with an embodiment described herein.

FIG. 10 is the display of an interface for editing the intersection information in accordance with an embodiment described herein.

FIG. 11 is an illustration of the dynamic time-space diagram in accordance with an embodiment described herein.

FIG. 12 is an illustration of the replay function in accordance with an embodiment described herein.

FIG. 13 is the display of the statistics recorder for performance measures in accordance with an embodiment described herein.

FIG. 14 is a display of the interface for before-and-after analysis in accordance with an embodiment described herein.

### DETAILED DESCRIPTION OF THE INVENTION

This invention involves the development of virtual signal controllers and dynamic time-space diagrams in mobile devices for ease of evaluation and optimization of traffic signal systems. It is developed based on the inventors' idea that once the time running in a mobile device is precisely synchronized with the system clock of signal controllers, one can develop virtual signal controllers in the mobile device which will run exactly the same signal timing plans as that running in the field. This idea is innovative in that it allows traffic engineers to “move” signal controllers from the field to a portable device such as mobile phones, tablets, and even laptop computers. It is fundamentally different from the simulation based techniques which mimic the signal operation offline. This finding may lead to many real-world applications as one can literally carry all traffic signals of an entire city in his pocket, and most importantly these virtual signals in the mobile device run real-time signal timing plans as that running in the field.

The present invention presents one of the applications out of this idea. It takes advantage of the built-in GPS and video camera capabilities of a mobile device and integrates a vehicle's GPS trajectory into the time-space diagram derived from the virtual signal controller and uses the aggregated information to diagnose the problems and make improvements. The details of the invention are described below along with the graphical illustrations presented by the figures.

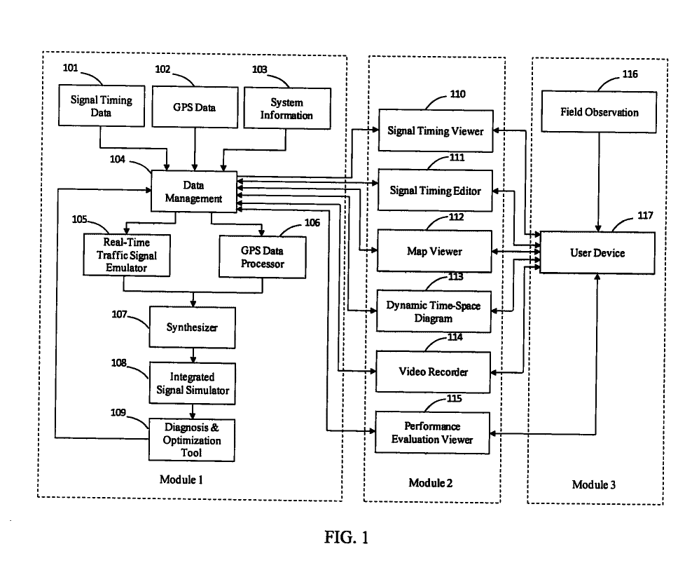

FIG. 1 illustrates the operating principle and major functions of the present invention. It is composed of three major components: 1) a module for collecting and processing traffic signal data and synthesizing it with vehicle movement data observed from the field, along with the analytical methods and functions for system diagnosis and optimization. It consists of nine key elements from 101 through 109 and is referred as Module 1 thereafter; 2) a module for collecting vehicle movement data from field observations by using mobile devices, which includes two fundamental elements 116 and 117 and is referred as Module 3 thereafter; and a module in between that provides all necessary interfaces between the field observation and the data processing and optimization modules, which includes six key elements from 110 to 115 and is referred as Module 2 thereafter.

In various embodiments, Module 1 provides most of the key functions for precise examination and optimal design of the signal timing plans. The first part of the module is centered on the data management body 104, which functions as the central database of the present invention. It receives, stores, and manages both traffic signal data and vehicle movement data. The signal timing data 101 include but are not limited to such parameters as the cycle length, split, phases, and offset of a traffic signal. They can be either manually coded through the Signal Timing Editor 111 in Module 2, or can be automatically downloaded to the database 104 from a traffic management center through the off-the-shelf signal timing tools such as Synchro. The GPS Data 102 include but are not limited to the information of vehicle trajectories, number of stops, travel time, speed, the coordinates of the intersections, and the real-time video files taken by the built-in video camera of the mobile device. The System Information Data 103 include but are not limited to the time to synchronize traffic signals by the agency, the time for transition of signal timing plans, and other data for daily traffic signal operation. Once the signal timing data are stored in the data management body 104, it can be viewed, in both graphical and the standard NEMA (National Electrical Manufacture's Association) double-ring formats in the Signal Timing Viewer 110 in the interface module.

The second part of the Module 1 is composed of the element 105, Real-time Traffic Signal Emulator; the element 106, GPS Data Processor; the element 107, Synthesizer; and the element 108, Integrated Signal Simulator. Some major functions provided by these elements include processing the traffic signal data and vehicles' movement data from field observation, synthesizing the data into one integrated platform, and developing visualized tools for signal timing analysis and optimization. In 105, a real-time signal emulator is developed to provide users with a virtual signal controller that runs on the mobile device with the exact same signal timing plan as that running in the field. This function is a major claim of this invention, which was made possible by synchronizing the time of the mobile device with the master clock of the signal controllers, and by accurately processing the signal timing data. In this invention, the signal timing information presented in the real-time signal emulator is demonstrated by the time-space diagram, which is a standard graphical illustration commonly used by traffic engineering professionals to examine signal timing plans. The GPS Data Processor 106 processes the vehicle movement information obtained from the field by the mobile device and develops a critical input usually referred as “vehicle trajectory” for signal timing evaluation and optimization. These two sets of information, namely the signal timing data in the form of time-space diagram provided by the real-time traffic signal emulator and the vehicle movement data in the form of vehicle trajectory provided by the GPS data processor are then integrated into the Synthesizer 107 and visualized through the Integrated Signal Simulator 108. In addition to visualization, a key function provided by the integrated simulator is to map a vehicle's trajectory onto the time-space diagram.

The third part of the Module 1 is a diagnosis and optimization tool 109 which is built upon the functions provided by the aforementioned elements. As a vehicle's movement information such as speed and number of stops can be fully interpreted by its trajectory, the performance of a traffic signal can be easily analyzed at this stage. A key feature of the tool lies in its capability of providing functions for both manual adjustment and automatic optimization of the signal timing parameters. The optimized signal timing data will be saved in the data management body 104 and examined through the same process depicted above. In other words, the functional elements 104 through 109 form a loop for diagnosis, evaluation and optimization until a perfect match is found between the vehicle trajectory and the time-space diagram.

With the data processing and signal optimization module fully described, attention now can be directed to the interface module, Module 2. In various embodiments 110 through 115, Module 2 provides links for two-way communication between the Module 1 and the Module 3, as well as all necessary interfaces for users to edit signal timing data, video data, the dynamic time-space diagram, and demonstrate results through the mobile user device.

In one embodiment, the Signal Timing Viewer 110 is designed for users to access the Data Management component 104 of Module 1 and display in real-time the status of the traffic signals such as the current time in cycle, the active phase and the time remaining in the phase, the double-ring phasing diagram, the referencing phase for coordination, and the offset.

In another embodiment, the Signal Timing Editor 111 provides a two-way interface between the user device 117 of Module 3 and the data management component 104. It allows users to edit data from the user device and then transfer the edited signal timing data to the Real-time Traffic Signal Emulator 105 through the data management system 104. This function is particularly useful in the case when detailed signal timing data is not available from a transportation agency through the input channels 101 and 103, and when the data must be collected from the Field Observation 116 in Module 3 due to other unexpected technical problems. With this function, users can simply input the observed data through the interface provided by the Signal Timing Editor 111. After further editing and analytic process in the Data Management component 104, the data are then used to develop the Real-time Traffic Signal Emulator 105 and translated into both graphical and professional formats for user to view in the Signal Timing Viewer 110.

As aforementioned, the Data Management element 104 of the Module 1 is designed for users not only to input data, but also edit data and develop customized information to assist other major functions such as the diagnosis and optimization tasks. A major function it provides is to automatically develop the time-space diagram based on the input signal timing data A time-space diagram is a commonly used diagram in the field of traffic engineering which uses time as the horizontal axis and space as the vertical axis, and uses horizontal bars at places where there are signalized intersections to represent traffic signal settings. These horizontal bars along the time axis are usually made informative to demonstrate such fundamental signal timing information as the duration and sequence of signal phases, cycle length, splits and offsets. The horizontal bar is segmented in length by the cycle length and phase intervals of a signal. When there are multiple signalized intersections, one can also use the time-space diagram to demonstrate the progression of green lights along a corridor from drawing slopped lines across the horizontal bars by using speed as the slope. Once the Data Management body 104 received and processed the signal timing data, it automatically produces time-space diagrams and allows a user to view it through the Dynamic Time-Space Diagram 113. In addition to provide views, a key feature of 113 lies in its capability of allowing users to edit and optimize the time-space diagram through the touch screen of the mobile user device. With the built-in dynamic functions in the present invention, one can make changes to the existing signal settings by rather simple operations. Although the present invention provides various built-in functions for signal optimization, the dynamic time-space diagram function provided by the element 113 also allows users to manually adjust the signal settings for the same purpose. For example, one can change the phasing sequence by dragging and relocating any segment of the bar, change the duration of a phase and/or the cycle length of the signal by enlarging or decreasing the size of the corresponding segments in the bar, and even make thorough changes to the whole signal settings.

Data collected from field observation via the mobile user device can be edited and processed by two other sophisticated embodiments, a Map Viewer 112 and a Video Recorder 114. The map viewer is designed to collect and process the coordinates of the intersections and show their locations on the digital map of the user device. The video recorder uses the camera of the user device to take videos during the field observation. A significant development associated with the element 114 is that the videos taken at different times can be demonstrated simultaneously on the same screen along with the detailed information of critical performance measures such as vehicle delay and number of stops at intersections. This function is particularly useful for users to conduct the before-and-after studies and make comparisons between the old and new signal timing plans. In addition to the function of video recording, the video recorder function is also designed to record real-time vehicle trajectories from the user device 117 through its built-in OPS receiver. The vehicle trajectory data and intersection coordinates are also transferred to and stored in the Data Management cell 104 where combined with the signal timing data, the present invention can accurately plot each individual vehicle's trajectory onto the time-space diagram on real time basis. The combined vehicle trajectory and time-space diagram information can then be utilized to analyze vehicle delay, stops, and queue length for performance evaluation. Using the functions provided by the elements 113 and 114, one can conduct comprehensive analysis against the performance of the old and new signal timing plans and view the results via the element 115, the Performance Evaluation Viewer.

The third and last module of the present invention includes two components, namely the Field Observation process 116 and the User Device 117, the carrier of the present invention which is a mobile device. Field observation involves driving a vehicle along the corridor of interest with the user device placed in a holder attached to the front window with the camera function turned on. With the functions described in this section, data collected from the test runs such as speed, trajectory, and number of stops will be automatically processed and synthesized with the signal timing data for view and analysis. Depending on the traffic conditions in the field, one can determine the number of runs needed to achieve the best performance. The user device in the present invention can be a smart phone, tablet, and laptop computers with GPS and video functions and Wi-Fi and 3G/4G internet services.

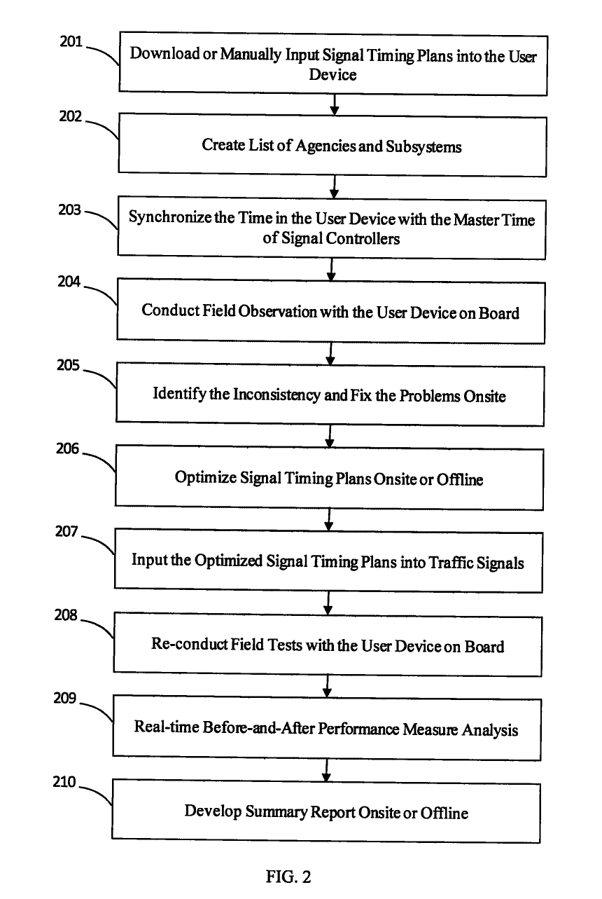

FIG. 2 is a flow chart illustrating the operating process of the present invention. Application of the invention starts from the step 201, in which a user inputs the existing or optimized signal timing plans into the user device either manually or by downloading from an out of the shelf signal timing tool such as Synchro. In the step 202, the signals are compiled in accordance with their operating agencies and grouped into subsystems for future analysis. A subsystem usually consists of a certain number of signals coordinated with each other along a major street or a highway corridor. The invention provides various interfaces for users to edit the information of the operating agencies and the subsystems of the traffic signals. Once the agencies and signal groups/subsystems are created, in the step 203 users will be able to synchronize the time of the user device with the system clock, i.e., the master time of the signal controllers so as to make the user device run precisely the same timing plan as that running in the controllers. With the signal timing information fully coded into the user device, one can use it to conduct field observations in the step 204. The field observation task involves driving an automobile vehicle along the corridor and observing the inconsistency between the actual signal timing running in the controller and that running in the user device. The inconsistency, if any, will be automatically recorded and reported, which usually is indicative of erroneous signal timing plans running in the controller. In the next step 205, the user can either fix the problem onsite by recoding the correct signal timing parameters into the controller, or take the user device and field observed data back to office for further analysis. In the step 206, the user may utilize the device for advanced analysis and optimization and develop new signal timing plans, either onsite or offsite. In the step 207, traffic engineers need to implement the new signal timing plans into the field so that the “after” data can be collected. In the step 208, the user will re-conduct field observations with the user device on board and examine the performance of the updated signal timing plans. In the step 209, the user can use the invention to generate statistics of the major performance measures such as average vehicle delay and number of stops at each intersection, for both before and after conditions. In the last step 210, the user can use the device to develop a summary report either onsite or in office to make precise comparisons of the before and after conditions.

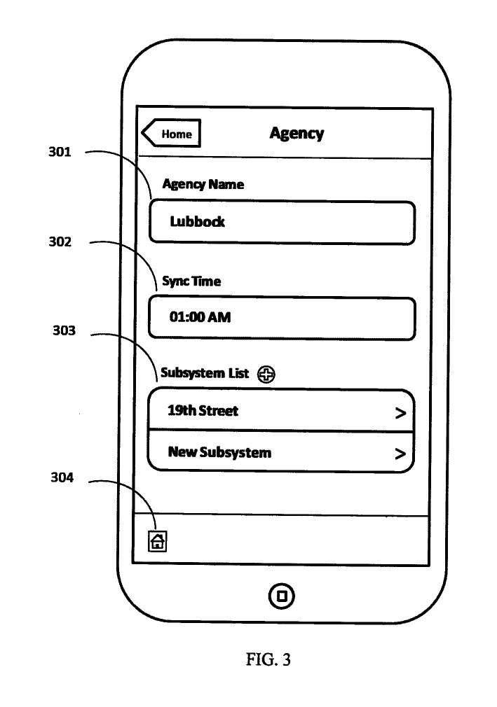

The present invention manages traffic signals according to their operating, agency and the subsystem they belong to based on their settings for coordination. A city's transportation agency usually operates hundreds of traffic signals and a subsystem often refers to an arterial street or a highway corridor consisting of a number of signalized intersections running in a coordinated mode FIG. 3 shows an interface for users to edit the information of a transportation agency. Using this interface, users are able to initialize the user device and code into the system such fundamental information as the name of the intersection, the operating agency, and the starting time for synchronization of the agencies. The window 301 contains the information of the local transportation agency and/or the name of the city/county where the traffic signals are located. Once the information are coded into e device, the time for synchronization can be set in the Synch Time window 302, which is the time when the signals are synchronized each day in the city. As signal controllers operated by the same transportation agency usually synchronize the signal time at a preset time point of a day, this information is the foremost and most critical input for the present invention to perform the diagnosis and evaluation. The following window 303 which is shown as Subsystem List allows users to select any single intersection or a set of intersections in the city and create multiple subsystems in the user device for separate analysis. Major information of a subsystem or an arterial can be edited through the interfaces in the next section. The icon 304 is a button for saving the edits and refreshing the whole interface for next input.

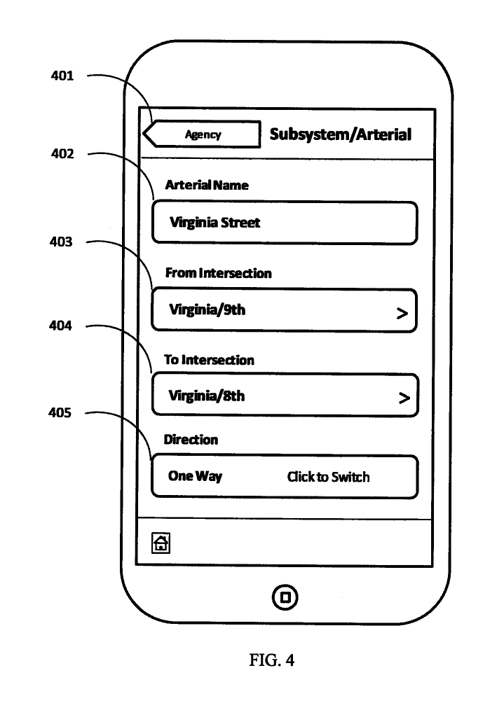

FIG. 4 is a display of the interface for editing subsystems and arterials. A street network is usually composed of a number of major arterial streets with each has a number of signalized intersections. Accordingly, traffic signals are usually coordinated with each other along an arterial street to reduce vehicle delay and number of stops. The interface shown in FIG. 4 allows users to edit the fundamental inputs of an arterial street, including the name of the arterial through the box 402, the name of the start and end intersections in the boxes 403 and 404 respectively, and the directional information of a two-way street through the button 405. Note the button 405 also provides the flexibility of switching from one direction to another. The button 401 links the arterial level and the agency level management.

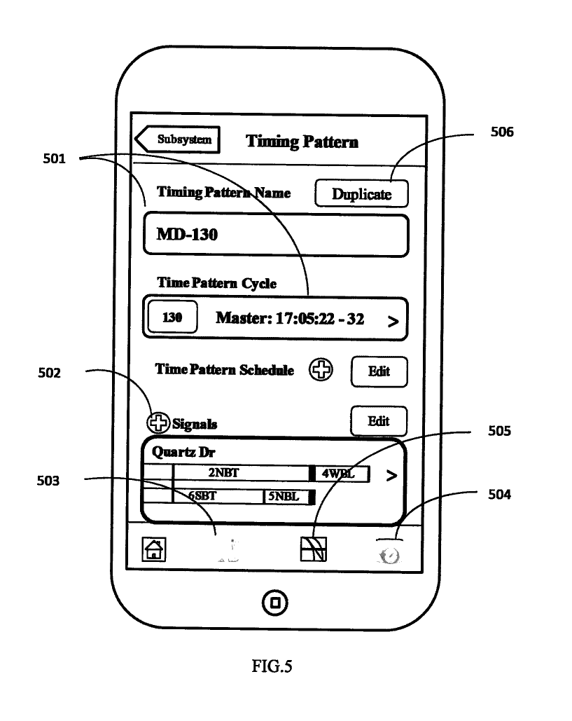

FIG. 5 shows the interface for users to edit the timing patterns and other key information of a new subsystem. The interface 501 includes several windows for editing the name of the timing pattern, cycle length, time of the master clock and the schedule of running a specific timing pattern in a day. The button 502 actives the editing window right underneath for users to add signals into the subsystem and edit the phasing information of each individual signal. To facilitate the task of editing and management, the map view of an intersection is made available and the button 503 provides this function. As part of the invention, a vehicle's trajectory can be recorded, stored, and retrieved for analytical purposes and the menu 504 allows users to retrieve the stored vehicle trajectories pertinent to the selected subsystem. Furthermore, as part of the major claims of the present invention, a built-in function is designed to automatically map a vehicle's trajectory onto the time-space diagram of the traffic signals in a mobile device, the button 505 activates this function and takes the user to the relevant view for performance analysis. As some intersections may run similar timing plans/patterns, the button 506 allows users to simplify the editing process by duplicating or modifying an existing plan.

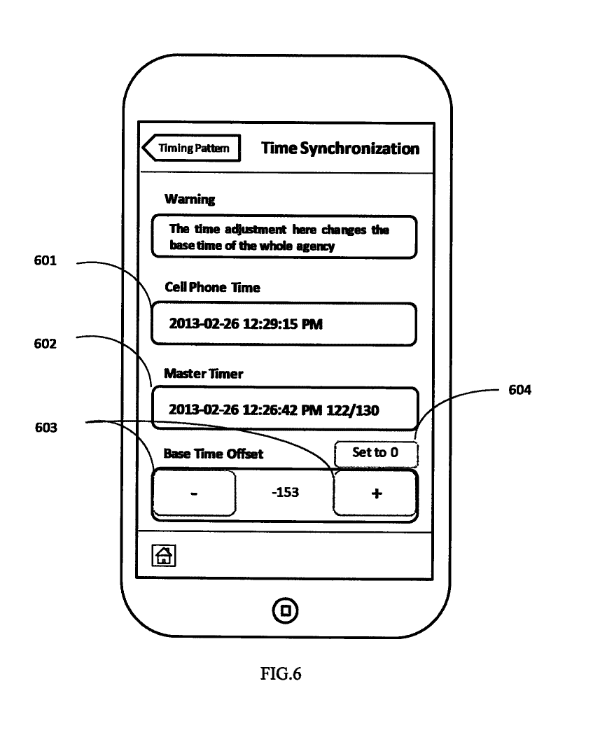

Once a subsystem is created, one can synchronize the times. FIG. 6 illustrates the interface for users to accurately, synchronize the time of the user device and the time of the master clock of a subsystem. Note that both the time of the user device and the time of the signal system clock are integrated into the interface. Because the time runs in the user device (a smart phone for instance) and that runs in a signal control system may have been set up in reference to different time systems, it may cause tiny errors. Users are allowed to precisely adjust the time of the user device using this interface to eliminate the error. The time information of the two systems is displayed in two display windows 601 and 602 and they are both editable. In a coordinated system, the base time offset is a fundamental setting to achieve coordination along an arterial. The button 603 allows users to edit this setting by adding or subtracting from the base time offset. The button 604 allows for resetting the offset to zero.

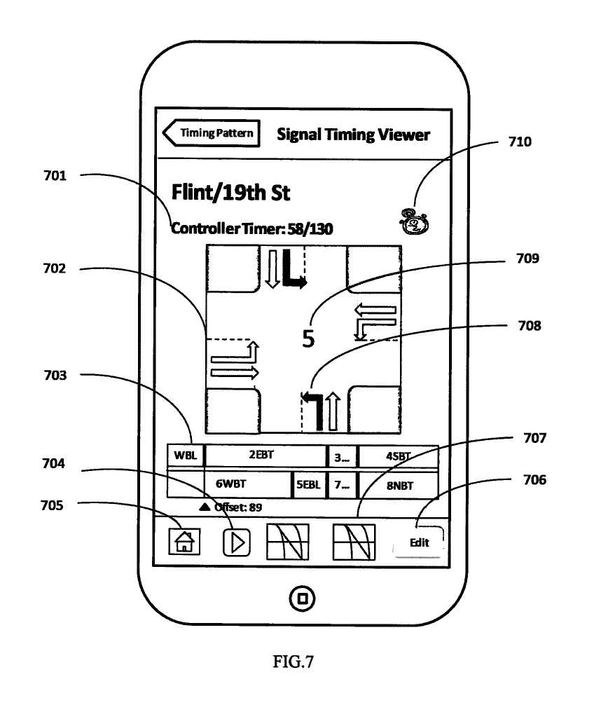

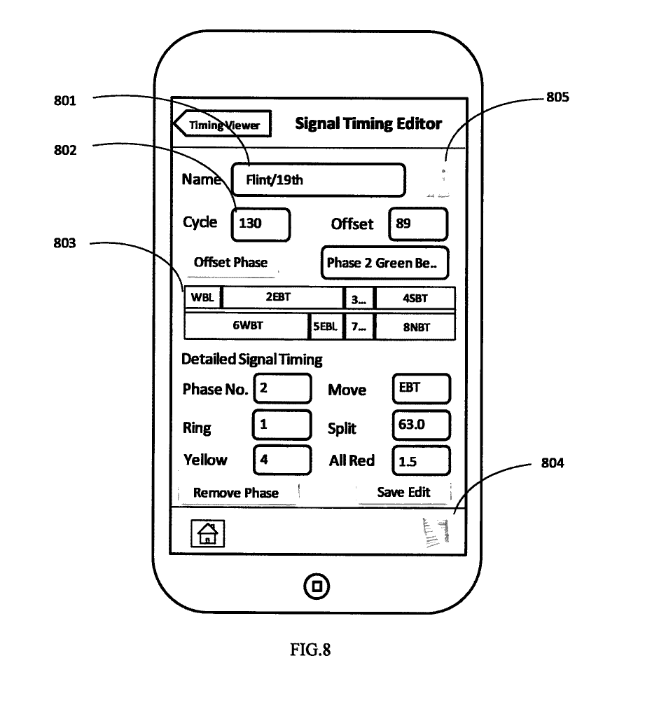

Illustrated in FIG. 7 is the signal timing viewer which is the interface of the virtual controller that shows the real-time signal time information of a select traffic signal. Specifically, it demonstrates, in both standard double-ring format and graphical illustration, the signal timing plan translated into the user device along with the local clock of the traffic signal that runs cyclically according to the cycle length. The window 701 shows the real-time information of the signal's local clock; the window 702 provides a vivid graphic view of the schematic of the intersection along with the indication of each signal phase; the window 703 shows the NEMA phasing diagram of the signal, the referencing point of the offset, and the offset setting of the signal; Considering users need to take test runs along an arterial street or highway corridor, a start/stop button 704 is designed to automatically start (or stop) to detect the next intersection the vehicle is approaching. The information of the downstream intersection such as the name and the phase that is currently active can be automatically updated. While the element 705 is a home button that allows the user to initialize or reset all settings in this display, the element 706 is designed to allow for editing any of the single settings pertinent to the signal timing plan in a separate interface to be illustrated associated with FIG. 8; the element 707 includes two buttons which are designed to open in full screen the pictures of the two-way time-space diagram of the corridor. The indications 708 and 709 show the current active phase and the time left in it before termination. The indication 710, which is a clock button, also provides the function of automatically synchronizing the time between the user device and the master time of the signal control system. In summary, the information demonstrated in the figure includes the name of the intersection, local clock of the signal in reference to the cycle length, the offset for coordination, the double-ring phasing diagram, and the real-time indication of the current time running in the active phase of the signal.

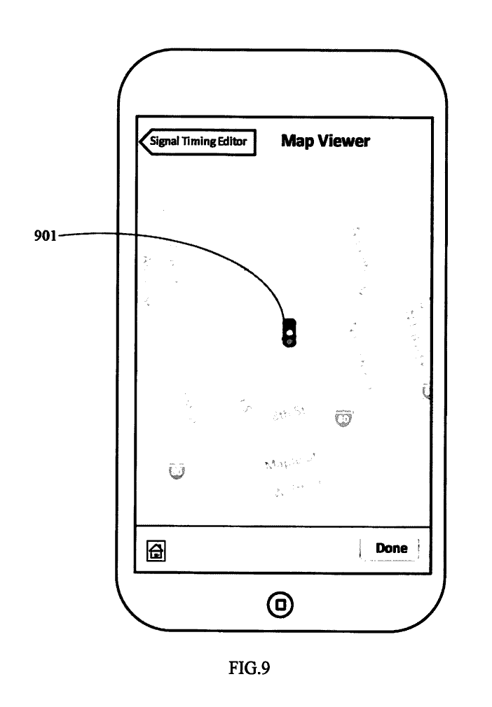

FIG. 8 illustrates the signal timing editor activated by the button 706. Using this interface, one can input detailed traffic signal timing plans into the user device, which includes the name of the intersection, cycle length, offset, phase number and sequence, movements, split, yellow time and all-red time of each phase. To start, the name of the intersections can be edited through the box 801. The graphical interface 802 shows the cycle length, offset, and the referencing phase of the offset. The interface 803 shows the double-ring phase diagram, which allows user to edit the phase sequence by dragging the sliding bars on the touch screen. When a phase is being edited, the signal timing parameters will be shown in the small windows underneath the double-ring diagram. Considering some transportation agencies may not be able to provide the signal timing plan currently running in a specific controller, a counting function is also provided for field observation and the button 804 activates this function. The button 805 allows users to view the location of the selected intersection in the digital map as shown in FIG. 9.

FIG. 9 is a display of the map viewer which provides the map view of the intersection of interest. The button 901 shows the location of the signalized intersection. By clicking the button a user can open a new window to get more details of the intersection such as the accurate coordinates, which is described below.

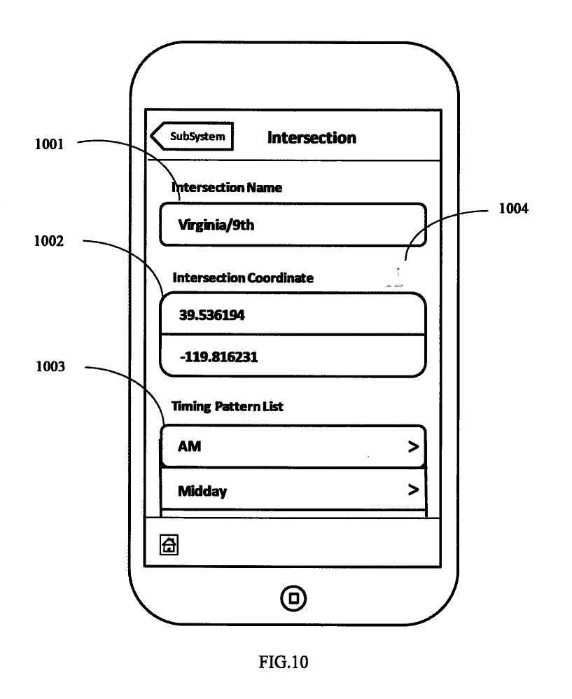

FIG. 10 is a display that provides details of the intersection and links the intersection level and the subsystem level managements. The button 1001 takes the user to the subsystem module to which the current intersection belongs. The name and coordinates of the intersection are shown in the windows 1002 and 1003, respectively. The menu 1004 shows the list of signal timing patterns associated with the intersection and indicates the current plan running in the signal. The button 1005 returns to the map view.

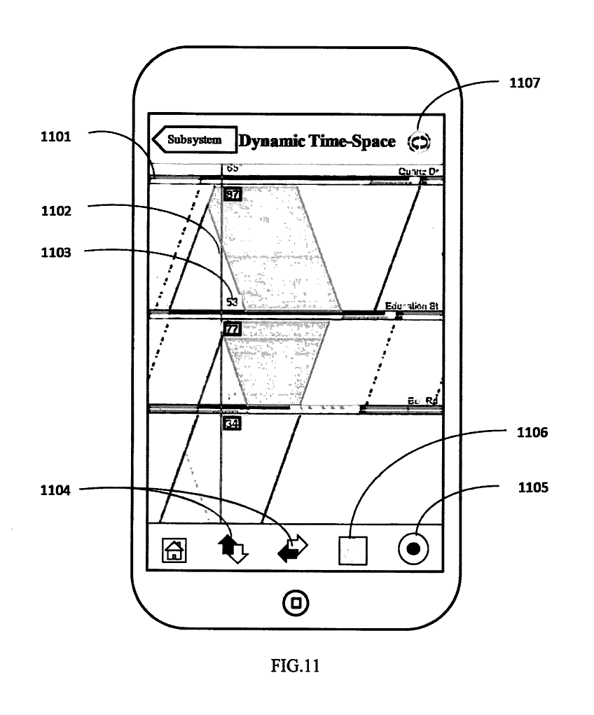

FIG. 11 illustrates the dynamic time-space diagram. Once the information of the intersections, arterial streets, and signal timing data are compiled into the system, the present invention provides a function to develop real-time dynamic time-space diagram to allow users not only view the current signal timing plan in real-time, but also to adjust the signal timing parameters directly from the touch screen of the user device by simply dragging and moving the bars with signal timing information. The three horizontal bars indicated by 1101 are very informative as they present all of the fundamental signal timing information such as phases, phase duration, phase sequence, and splits of the intersection which have been compiled into the user device at this stage. The shadowed bands between the horizontal bars represent the duration of the green phases of the major approaches and the progression of the green time through the intersections. Every individual component of the bars can be moved and repositioned by dragging through the touch screen and this operation provides the users an opportunity to optimize the signal timing plan by manual adjustments. The vertical line and the numbers attached to it, which is indicated by the codes 1102 and 1103 respectively, demonstrate the real-time information of the current time in the signal cycle. The line slides second by second through all intersections to mimic the movement of the signal clock. At places where the line intersects with the horizontal bars it gives two critical information, one is the indication of the current active phase at each intersection, and the other is the time remaining in the active phase before switching to the next phase. An intersection is composed of multiple approaches and signal coordination is usually provided to accommodate the through movements of major approaches. At critical junctions where two arterial streets intersect with each other one may want to examine the signal timing performance for both streets, the icon 1104 allows the user to switch between the major approaches of an intersection. The icon 1105 actives the function to record the vehicle's trajectory and the icon 1106 activates the function to provide the hands-free street view. The icon 1107 switches between the real-time street view and the dynamic time-space diagram.

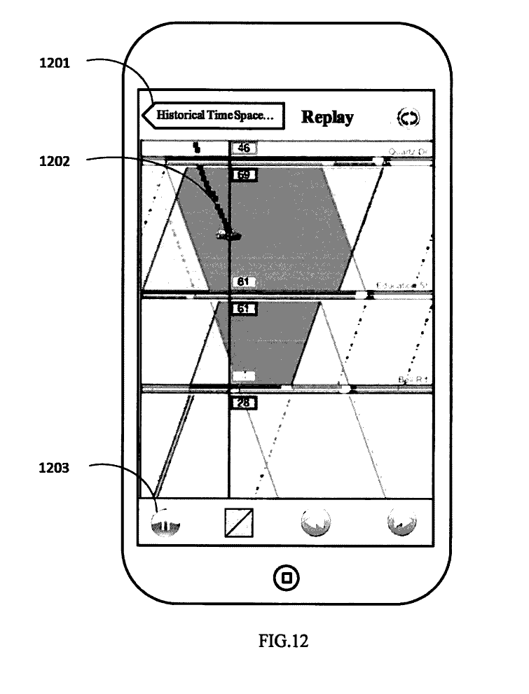

In the present invention, the diagnosis and optimization of signal timing plans is made possible by first precisely mapping the vehicle's trajectory onto the time-space diagram and then checking their relevant relation. This task requires frequent observation of historical data regarding the vehicle's movement on the time-space diagram as shown in FIG. 12. In this function, any historical time-space diagram and vehicle movement data collected from the field can be replayed for detailed analysis. The icon 1201 allows the user to select the historical episode and the icon 1202 emulates the vehicle's movement based on the speed data recorded in the field. The icons underneath the figure, indicated by 1203 are the control buttons for replay and the hands free button for street view. A unique feature of the present invention lies in its capability of recording in real-time the commonly used performance measures such as the travel time, average speed, and number of stops of a vehicle along with the detailed settings of traffic signals. The trajectory emulation and episode replay function are critical to both online and offline examinations.

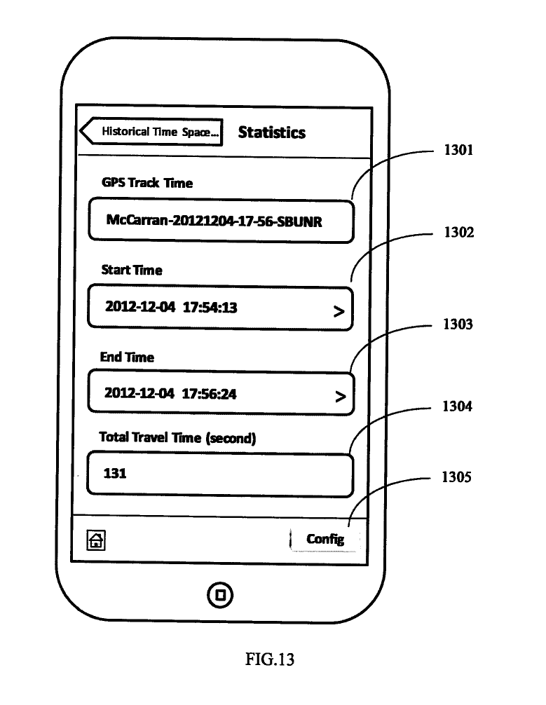

In the present invention, a vehicle's movement can be automatically, recorded by the user device. FIG. 13 illustrates an interface that displays the statistics related to a vehicle's movement along an arterial. The GPS track time of the user device is shown in the box 1301. The start and end time of a complete trip as well as the travel are indicated in the boxes 1302, 1303 and 1304 respectively. The button 1305 allows a user to configure the statistics.

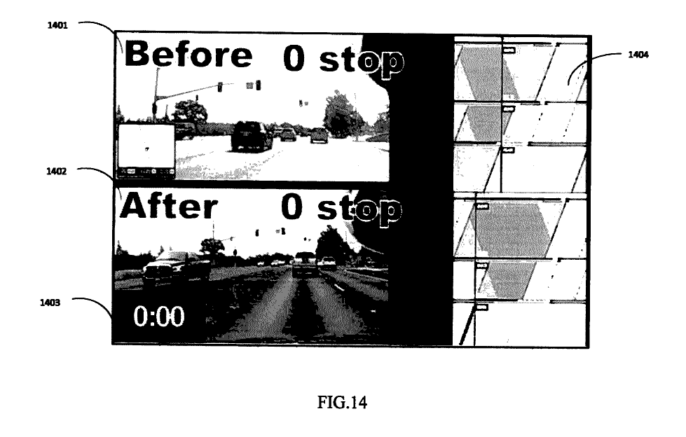

FIG. 14 demonstrates two other function of the present invention for performance evaluation. Combined, they provide a key function of the invention for measuring the performance of the old and new signal timing plans. It provides the user with an integrated interface that shows the videos of the before and after conditions simultaneously as indicated by 1401 and 1402, respectively. Together with the time recorder indicated by 1403, users can easily make comparisons between the old and new signal timing plans, based on the travel time and number of stops in the before and after conditions. Furthermore, as indicated by the element 1404 the old and new time-space diagrams are also shown in the same graph for users to make the in-depth comparisons

What are claimed are:

1. A mobile application for real-time management, operation and optimization of traffic signal control systems, comprising,
a concept to developing an interactive and user friendly tool for evaluation and optimization of traffic signal timing plans via mobile devices;
a method to synchronizing the master time of traffic signal controllers with the time of a mobile device and using this technique to develop virtual traffic signal controllers in the mobile device; and
a data management body configured to collect, store and process the traffic signal data and the vehicle movement data in a mobile device; and
a method that allows a human operator to directly transfer traffic signal timing information from a transportation agency to a mobile device; and
a method to demonstrating the real-time signal timing information through the function of the signal timing viewer; and
a method that allows a user to directly edit the signal timing data via an editable interface in the mobile device; and
a method to developing dynamic time-space diagrams that are editable through the touch screen of a mobile device; and
a method to automatically mapping a vehicle's trajectory onto the dynamic time-space diagram in a mobile device; and
a method to using a mobile device to synthesize the signal timing data with the vehicle movement data and integrating the data into a simulator for real-time demonstration; and
a method to developing various interfaces in a mobile device for users to edit and view precise information of signalized intersections, arterials, and transportation agencies; and
a method to switching between map views and signal timing views of a signalized intersection with accurate coordinates in a mobile device
a method to using the mobile application to diagnose the problems of a traffic signal controller and optimize signal timing plans accordingly; and
a method to collecting video and performance measures data via a mobile device for before-and-after studies; and

[symbol]

2. The application of claim 1, wherein the said virtual signal controller runs the exact same signal timing plans as that running in the field.

3. The application of claim 1, wherein the said virtual signal controller provides editable interfaces for users to edit and view the signal timing information.

4. The application of clam 1, where the said signal timing viewer provides real-time information of a traffic signal in an integrated interface, including the standard NEMA double-ring diagram, the active phase, the time remaining in the active phase, and the time-space diagram.

5. The application of claim 1, wherein the said editable signal timing interface allows a user to manually input the signal timing parameters which either create a new setting or override the settings downloaded from a transportation agency.

6. The application of claim 1, wherein the said dynamic time-space diagram involves a function that allows a user to manually adjust the signal timing parameters by directly dragging and relocating the informative bars via the touch screen.

7. The application of claim 1, wherein the said dynamic time-space diagram involves using a sliding bar to mimic the second by second movement of a traffic signal's local clock.

8. The application of claim 1, wherein the dynamic time-space diagram involves attaching to the sliding bar the real-time information of the time remaining in the current active phase at each signalized intersections.

9. The application of claim 1, wherein the said real-time time-space diagram involves built-in functions to display the real-time vehicle trajectory in a mobile device.

10. The application of claim 1, wherein the functions for before-and-after studies involve integrating the video data and the corresponding dynamic time-space diagram into one platform and demonstrate via the mobile device for ease of analysis.

11. The application of claim 1, wherein the invention involves developing online analysis reports and uploading the information to cloud and/or to a traffic management center directly from a mobile device.
